(19) United States
(12) Patent Application Publication
(10) Pub. No.: US 2025/0337166 A1
(43) Pub. Date: Oct. 30, 2025

(54) Long Deployable Helix Antenna

(71) Applicant: TENDEG LLC, Louisville, CO (US)

(72) Inventor: Mark Thomson, Tucson, AZ (US)

(73) Assignee: TENDEG LLC, Louisville, CO (US)

(21) Appl. No.: 18/648,152

(22) Filed: Apr. 26, 2024

(51) Int. Cl. H01Q 11/08; H01Q 1/08; H01Q 1/48; H01Q 21/28

(52) U.S. Cl. CPC H01Q 11/086; H01Q 1/08; H01Q 1/48; H01Q 21/28

(57) ABSTRACT

A helix antenna and methods of making and using helix antenna to concurrently or independently radiate pulses in a very high frequency (VHF) band in a range of about 240 MHz to about 270 MHz and/or in an ultrahigh frequency (UHF) band in a range of about 360 MHz to about 380 MHz which can be useful in space to ground data transmissions, subsurface radar, and measurement of ice and snow pack.

### I. FIELD OF THE INVENTION

A helix antenna and methods of making and using helix antenna to concurrently or independently radiate pulses in the range of about 30 MHz to about 3 GHz, and in particular embodiments in a very high frequency (VHF) band in a range of about 240 MHz to about 270 MHz or in an ultrahigh frequency (UHF) band in a range of about 360 MHz to about 380 MHz which can be useful in space to ground data transmissions, subsurface radar, and measurement of ice and snow pack.

### II. BACKGROUND

Axial-mode helical antennas were inspired by helices used in traveling-wave tubes. Helical antennas consist of a spiral conductor placed above a conducting ground. The radiation pattern of a helical antenna can be concentrated about the antenna axis with a field polarization in the axial direction being substantially circular. The polarization sense (right-hand circular or lefthand circular) corresponds to the sense of spiral winding (right-hand, viz. left-hand spiral). Helical antennas can be used in terrestrial and satellite communication systems.

### III. A BRIEF DESCRIPTION OF THE DRAWINGS

FIG. 1A is a perspective view of a particular embodiment of the inventive antenna in the stowed condition.

FIG. 1B is a perspective view of a particular embodiment of the inventive antenna in the stowed condition.

FIG. 2 is first side elevation view of the antenna in the stowed condition.

FIG. 3 is second side elevation view of the antenna in the stowed condition.

FIG. 4 is a first end elevation view of the antenna in the stowed condition.

FIG. 5 is a second end elevation view of the antenna in the stowed condition.

FIG. 6 is a top plan view of the antenna in the stowed condition.

FIG. 7 is a bottom plan view of the antenna in the stowed condition.

FIG. 8 is a perspective exploded view of the particular embodiment of the antenna depicted in FIG. 1A in the stowed condition.

FIG. 9 is a first side elevation exploded view of the inventive antenna in the stowed condition.

FIG. 10 a perspective view of the antenna in the deployed condition.

FIG. 11 is is first side elevation view of the antenna in the deployed condition.

FIG. 12 is second side elevation view of the antenna in the deployed condition.

FIG. 13 is a first end elevation view of the antenna in the deployed condition.

FIG. 14 is a second end elevation view of the antenna in the deployed condition.

FIG. 15 is a top plan view of the antenna in the deployed condition.

FIG. 16 is a bottom plan view of the antenna in the deployed condition.

FIG. 17 is an enlarged perspective view of the portion of the antenna depicted in FIG. 10 in the deployed condition.

FIG. 18A is a top plan view of an antenna bulkhead including an antenna bulkhead hub including a stem guide.

FIG. 18B is an enlargement of a vertex cap depicted in FIG. 18A.

FIG. 19 is a perspective view of a stem guide.

FIG. 20 is a top plan view of a stem guide.

FIG. 21 is a first side perspective view of the antenna deployer.

FIG. 22 is a first side elevation view of the antenna deployer.

FIG. 23 is a second side elevation view of the antenna deployer.

FIG. 24 is a first end elevation view of the antenna deployer.

FIG. 25 is a second end elevation view of the antenna deployer.

FIG. 26 is a top plan view of the antenna deployer.

FIG. 27 is a bottom plan view of the antenna deployer.

FIG. 28 is a perspective first side exploded view of the antenna deployer.

FIG. 29 is a first side elevation exploded view of the antenna deployer.

### IV. DETAILED DESCRIPTION OF THE PREFERRED EMBODIMENTS

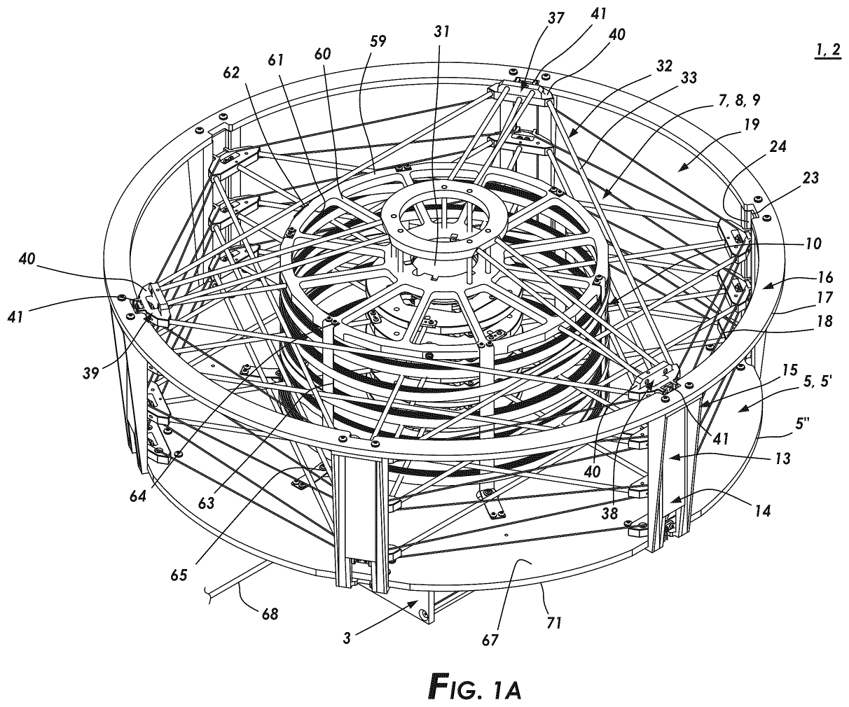

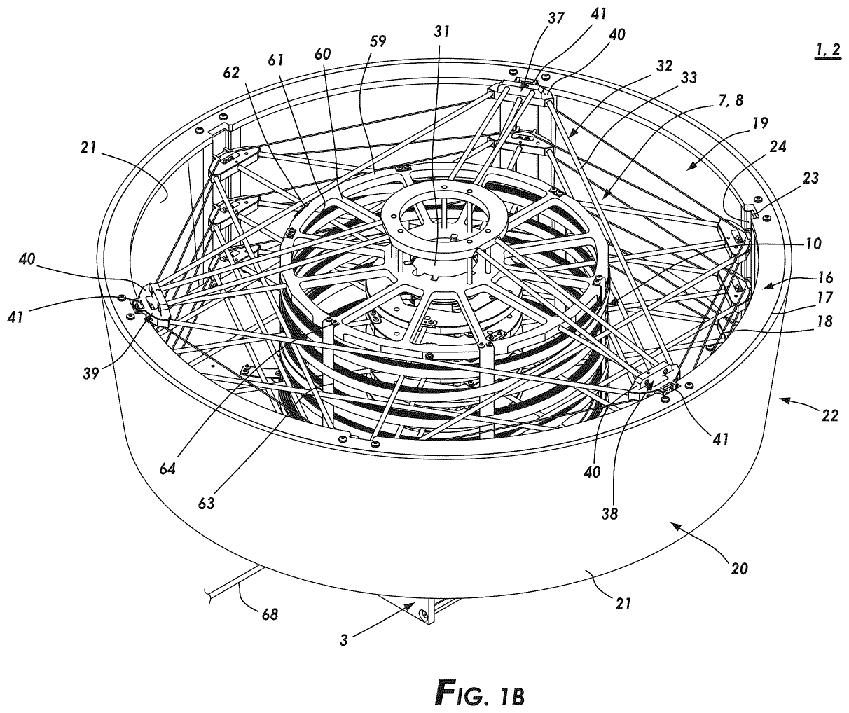

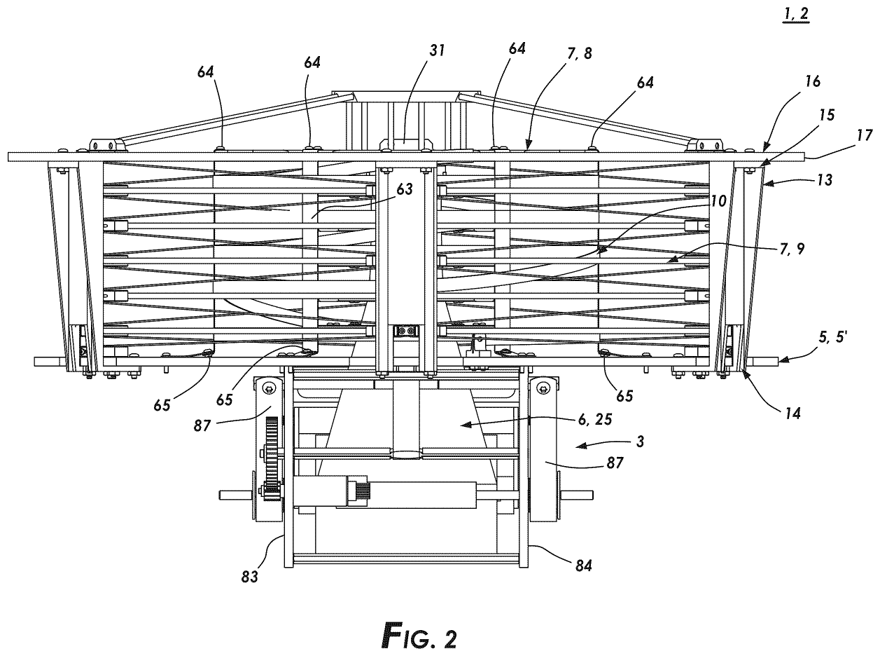

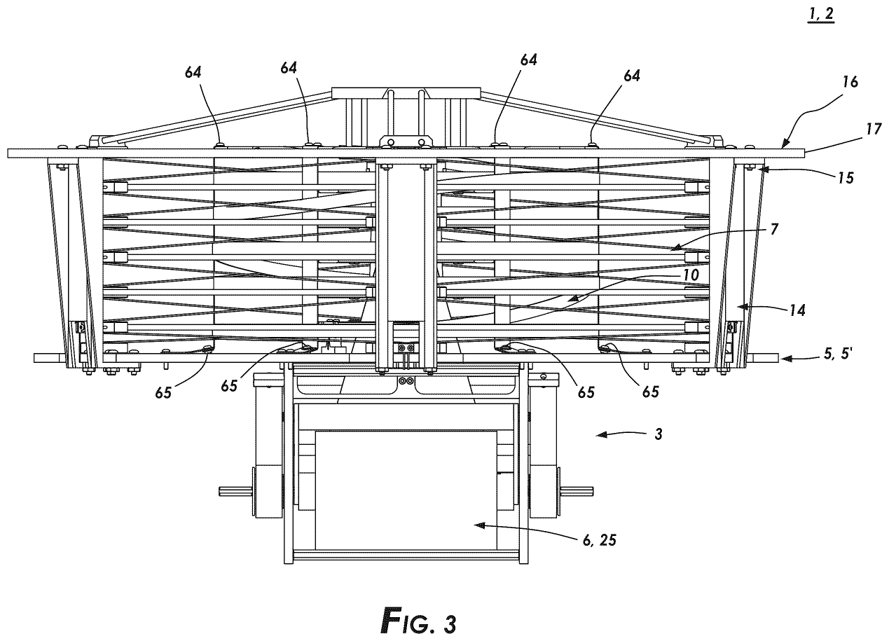

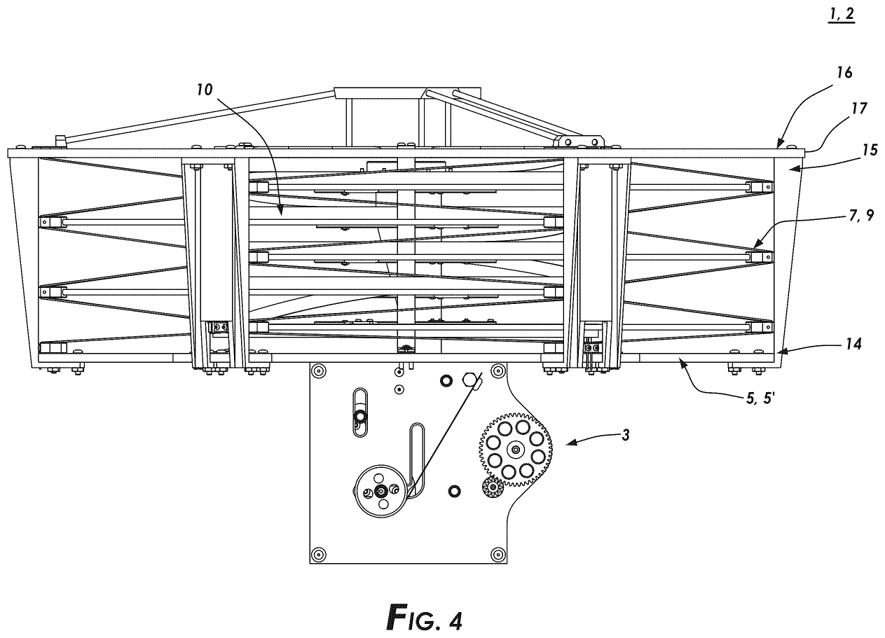

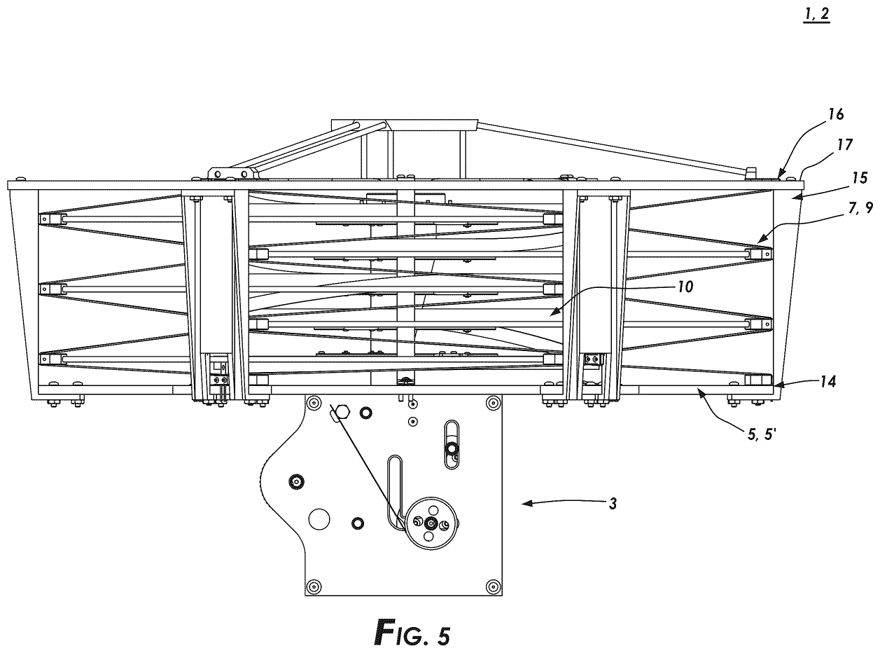

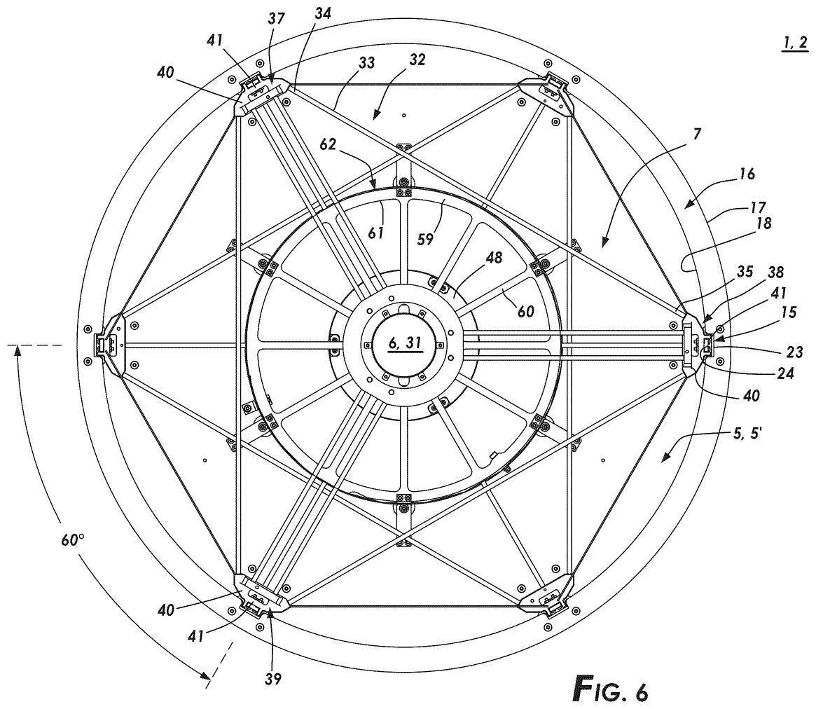

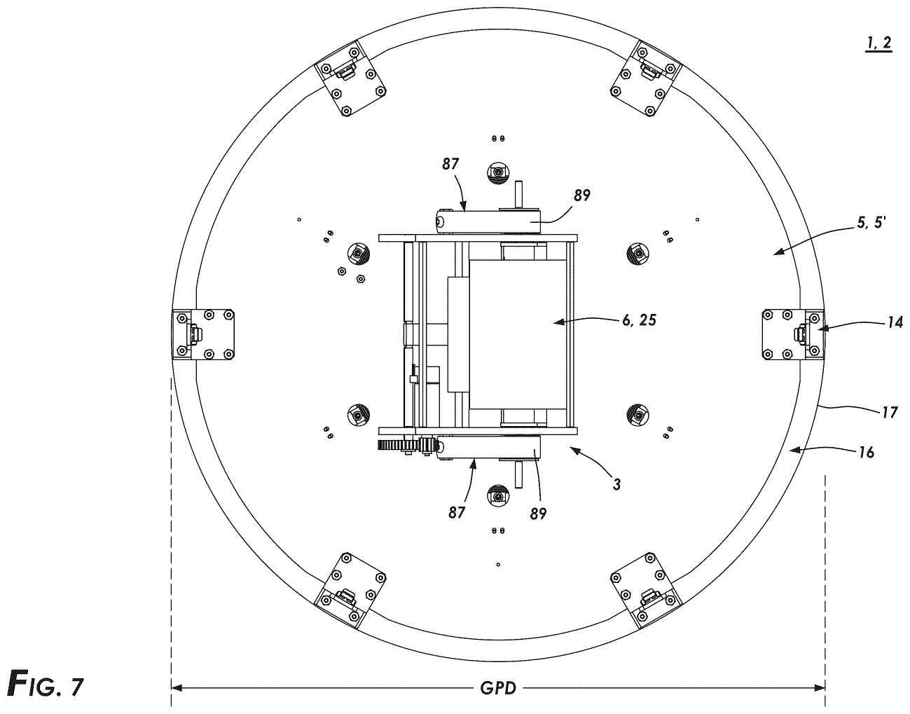

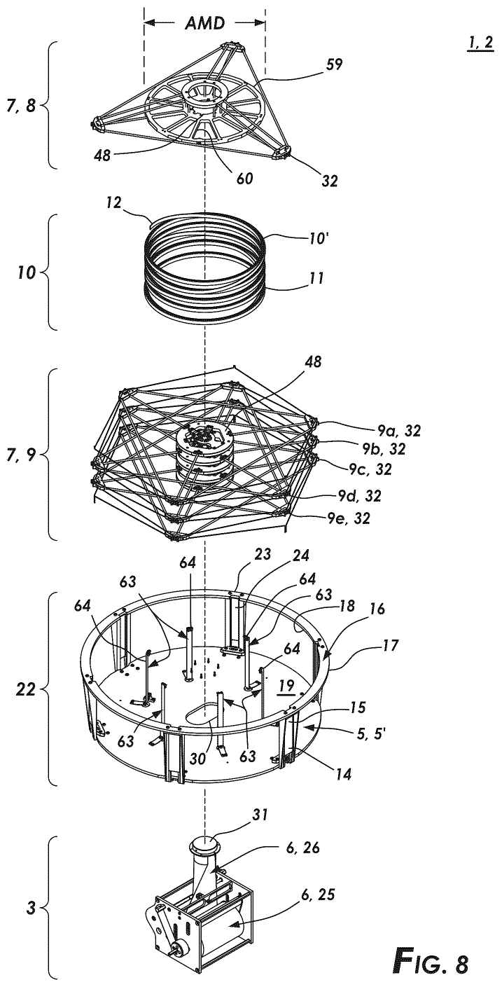

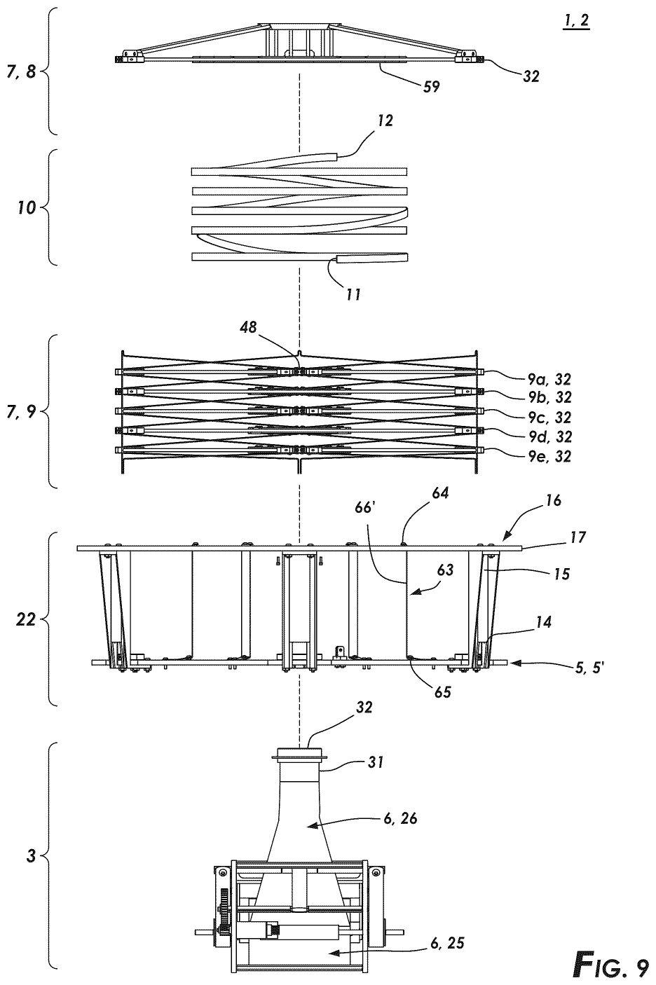

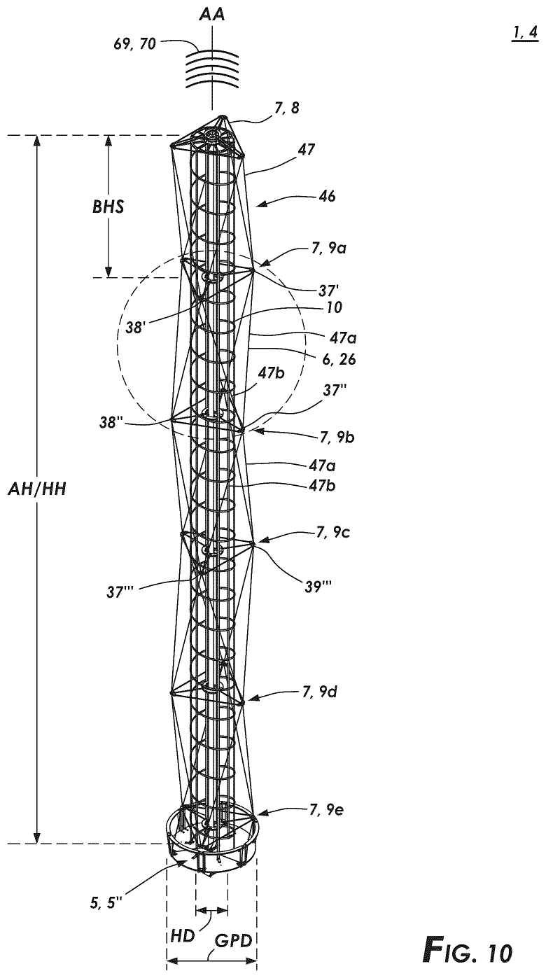

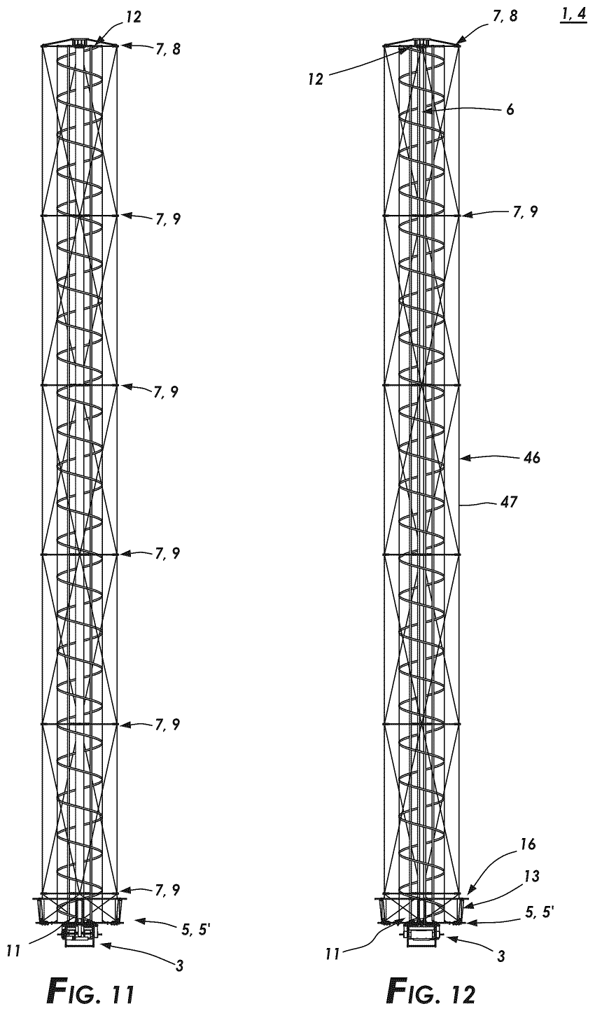

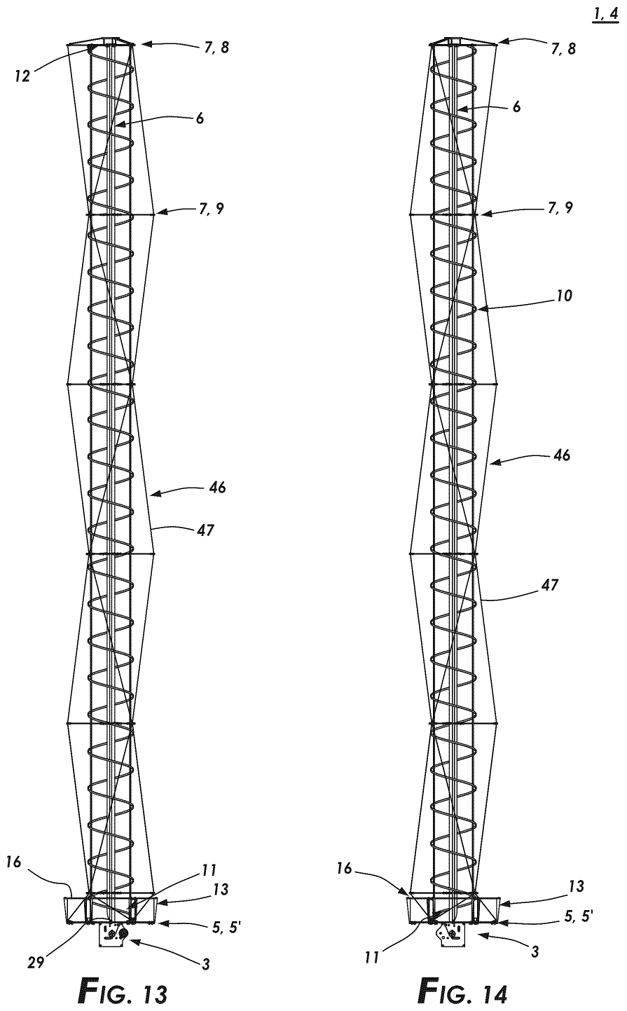

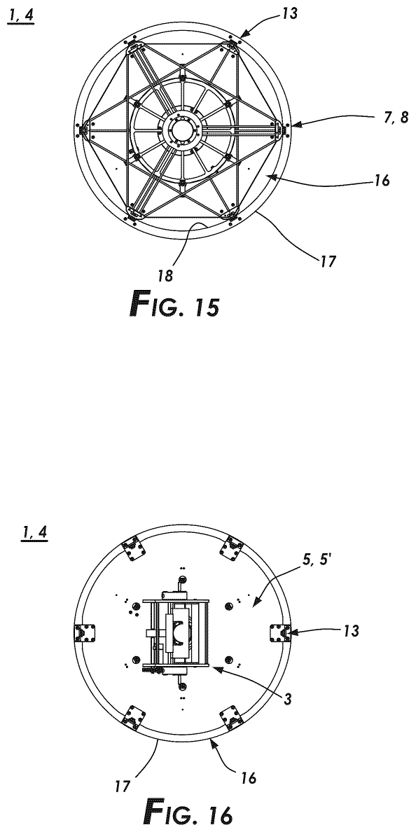

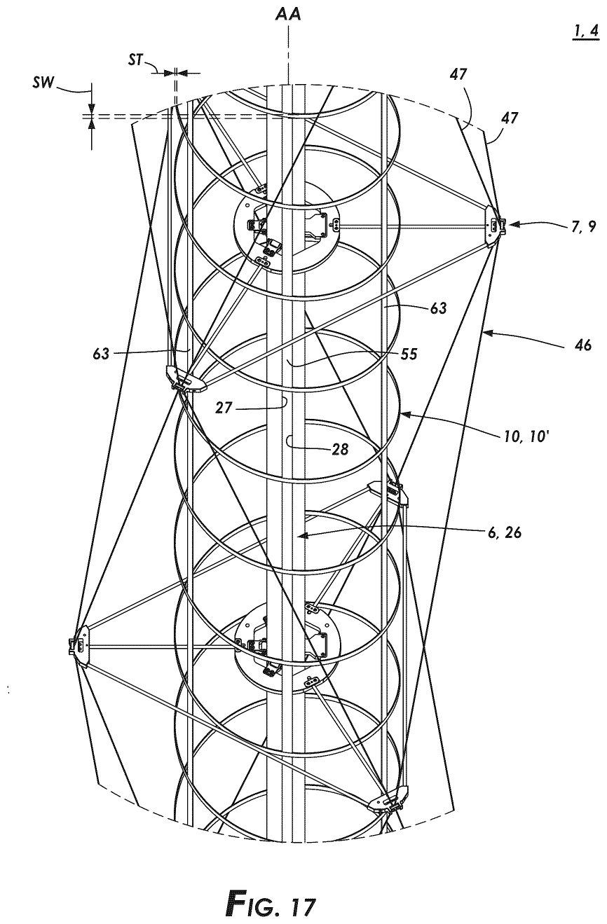

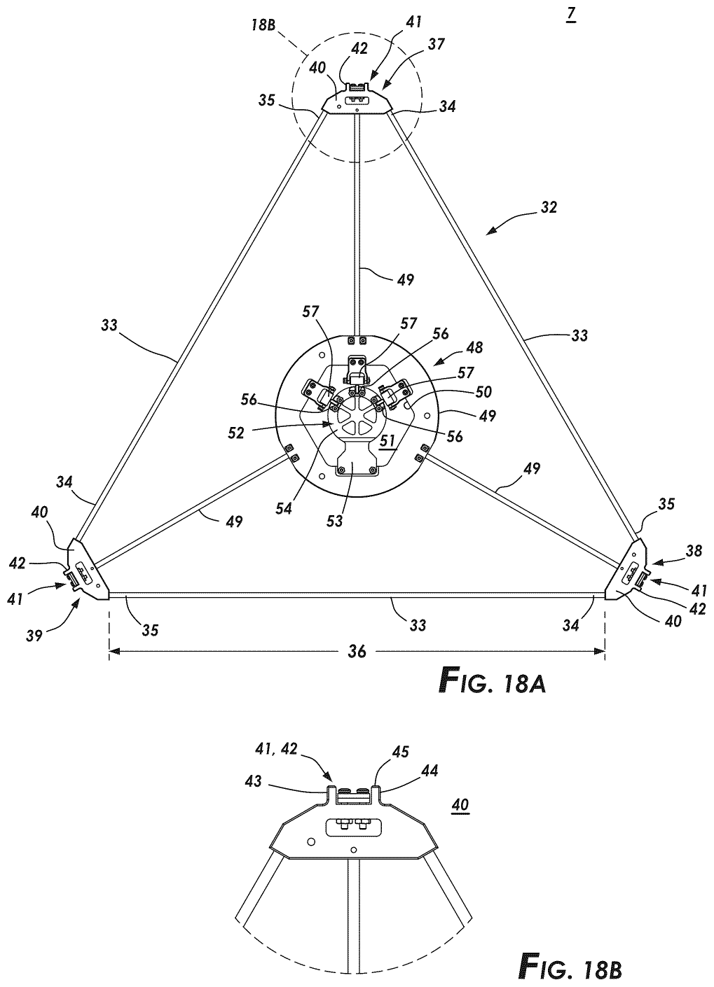

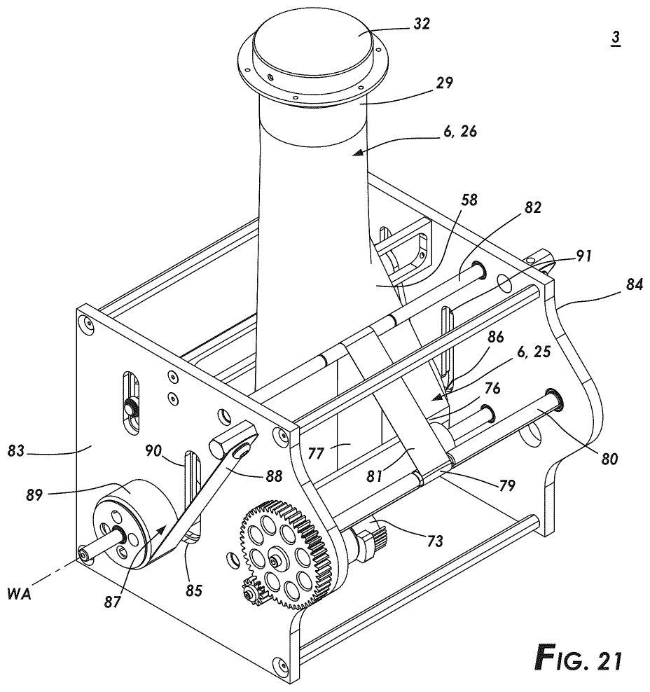

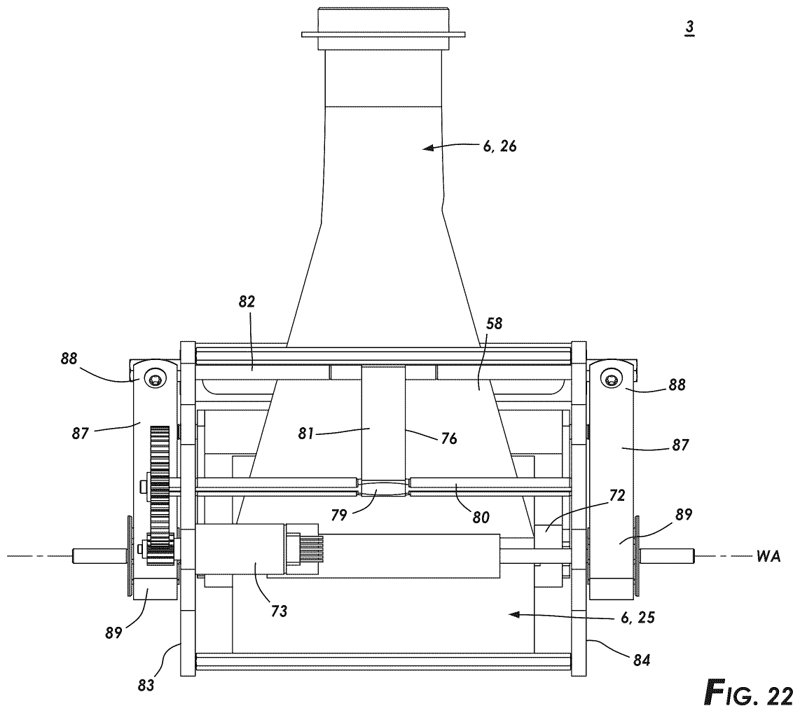

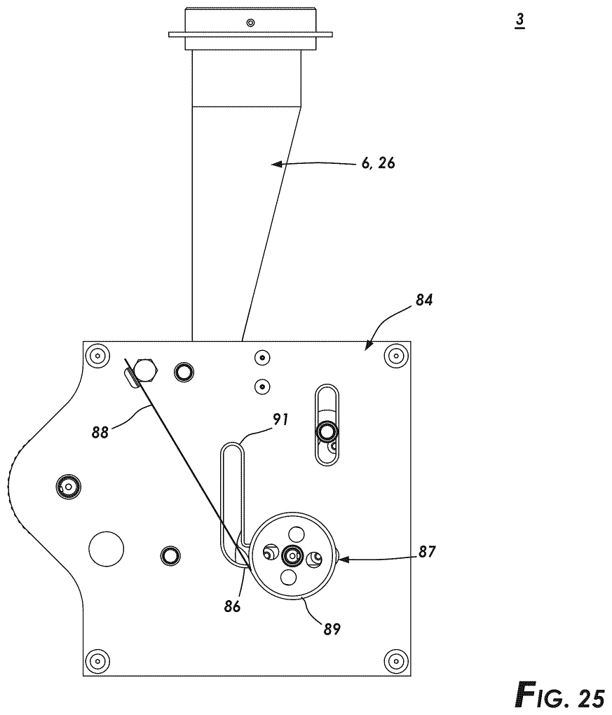

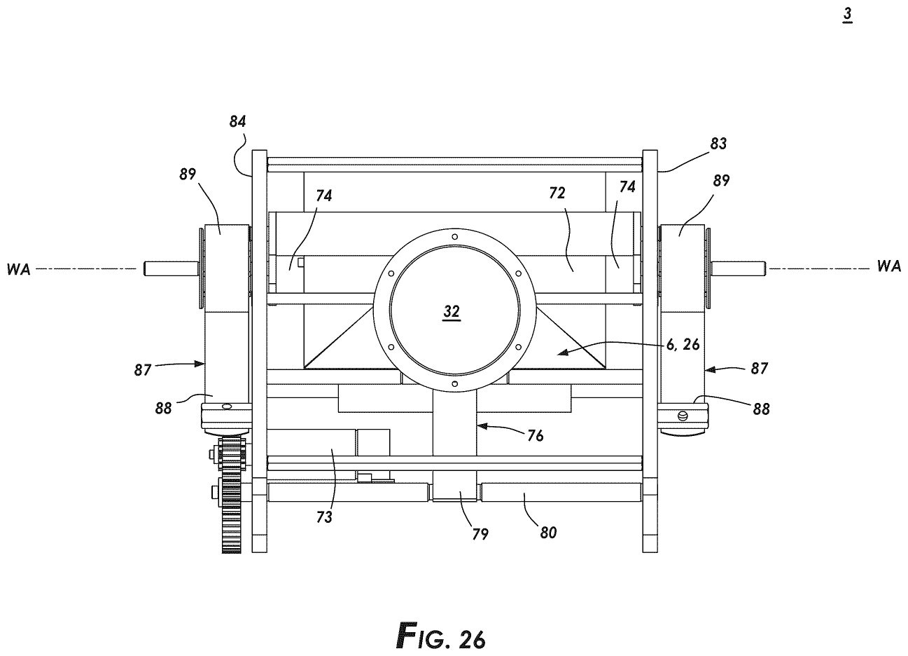

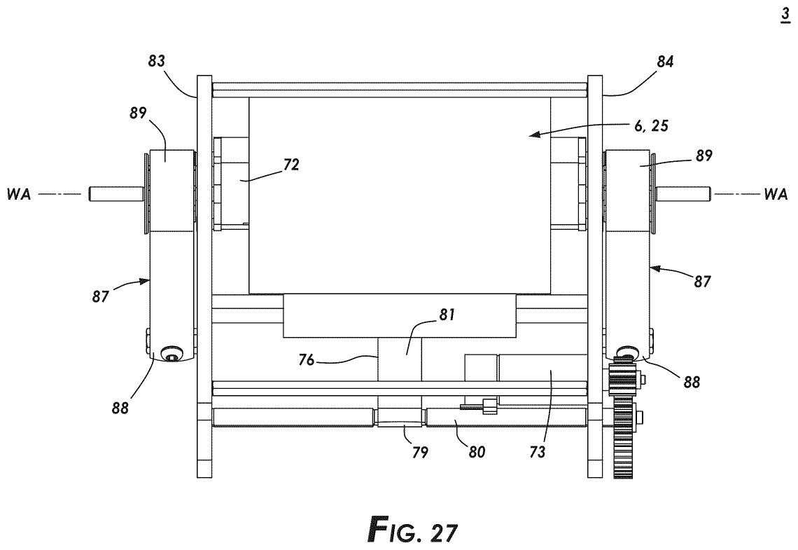

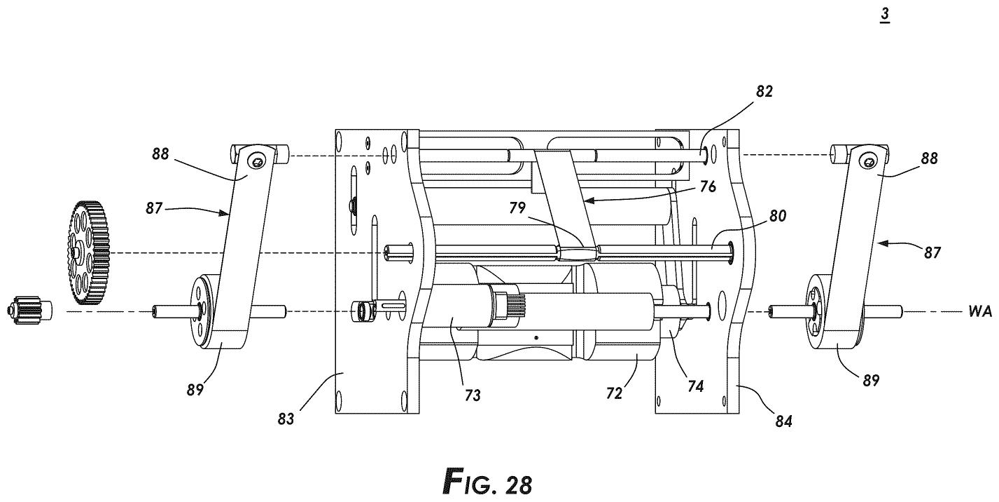

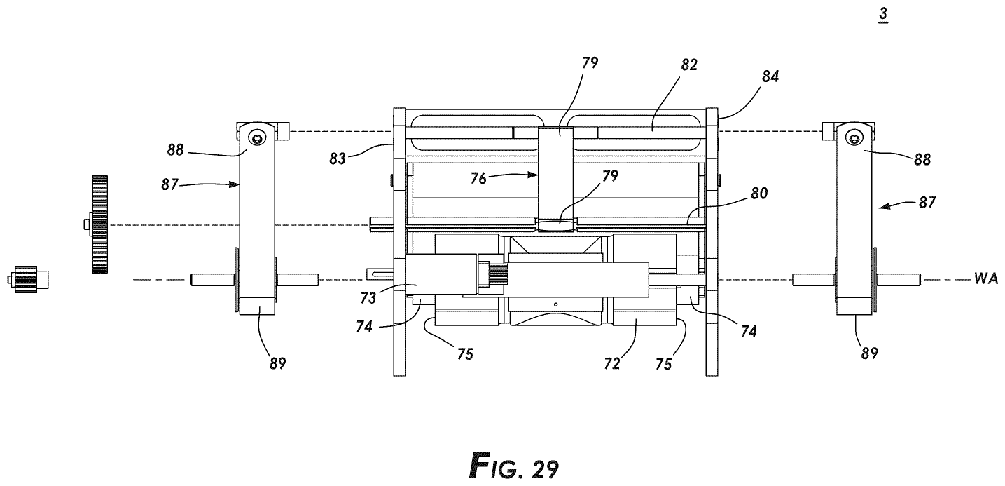

Generally, with reference to FIGS. 1A through 29, illustrative embodiments are depicted of an inventive helix antenna (1) and methods of making embodiments the helix antenna and methods of using embodiments of the helix antenna (1). Particular embodiments of the helix antenna (1) deploy from a stowed condition (2) (as shown in the examples of FIG. 1A through 9) by corresponding operation of an antenna deployer (3) toward a deployed condition (4) (as shown in the examples of FIGS. 10 through 17).

With primary reference to FIGS. 1A through 17, in particular embodiments the invention can include one or more of: a base plate (5), which in particular embodiments can be configured as a ground plane (5′), a stem (6) retractably extendable in spatial relation to the base plate (5), or the ground plane (5), a plurality of bulkheads (7) including a terminal bulkhead (8) coupled to the stem (6) and a plurality of intermediate bulkheads (9) slidably disposed on the stem (6), and one or more helix(es) (10) of electrically conductive material can be helically disposed around the stem (6) between corresponding a helix first ends (11) coupled to the base plate (5), or the ground plane (5′), and a helix second end (12) coupled to the terminal bulkhead (8).

In particular embodiments, the base plate (5) affords a structure to which components of the antenna can be mounted, and in particular embodiments when configured as a ground plane (5′) or reflecting surface, it can assist to directionally focus the radiation generated by the one or more helix(es) (10). The ground plane (5) can be in several forms with the usual reflecting surfaces being a flat solid plate of electrically conductive material (as shown in the examples of FIGS. 1A and 10) or alternately comprise a electrically conductive mesh screen, radially extending spokes, solid sidewall (as shown in the example of FIG. 1B), or combinations thereof. The configuration of the ground plane (5′) can affect the antenna radiating pattern. For example, antenna radiating patterns obtained using a helix antenna (10) radiating over square ground planes can yield radiating patterns including radiating pattern sidelobes.

Accordingly, while the ground plane (5) can be infinite, square or other configuration, particular embodiments of the inventive helix antenna (1) can use a circular ground plane (5″) comprising a circular plate of electrically conductive material, including metals such as aluminum or copper, although in certain applications, carbon reinforced polymers or carbon fiber composites may also be utilized. In the case of a circular ground plane (5″), the diameter can be at least one-half the operational wavelength of the helix antenna (1). The radiating pattern of a helix antenna (1) using a circular ground plane (5″) can be concentrated about the antenna axis (AA) (as shown in the example of FIG. 10), and the field polarization in the axial direction can be substantially circular.

Again, with primary reference to FIGS. 1A through 16, in particular embodiments, a plurality of upright supports (13) having a support length disposed between a support first end (14) and a support second end (15) can be disposed in circumferential fixed spaced apart relation on the base plate (5), or around a ground plane circular perimeter (5′″) of the ground plane (5′). In a particular embodiments, the support first ends (14) can be coupled proximate the ground plane circular perimeter (5′″) of the circular ground plane (5″) and the support second ends (15) can be coupled to a circular annular ring (16) including an outer annular edge (17) having a diameter substantially similar to the ground plane diameter (GPD) of the ground plane (5′). The ground plane (5), the plurality of upright supports (13) and an inner annular edge (18) of the circular annular ring (16) can define an interior space (19) above the base plate (5) or the ground plane (5′). In particular embodiments, an electrically conductive circular sidewall (20) can be joined to the ground plane circular perimeter (5″) of the ground plane (5′). The circular side wall (20) can comprise an electrically conductive sheet, mesh, net or spokes of material. The ground plane (5′) and a sidewall internal surface (21) can define the interior space (19) above the ground plane (5′). The ground plane (5′), along with the plurality of upright supports (13) and annular ring (16) or the circular sidewall (20), can be referred to as a cup (22). The cup (22) defines the interior space (19) in which the helix antenna (1) can be disposed in the stowed condition (2) (as shown in the examples of FIGS. 1A through 9). In particular embodiments, an open-sided channel (23) can be disposed in each of the plurality of upright supports (13) or disposed in the circular side wall (20) in circumferential spaced apart relation around the circular perimeter (5′″) of the ground plane (5′) to provide a corresponding plurality of channels (24). In the illustrative examples, the plurality of upright supports (13) each including an open-sided channel (23) comprise six upright supports (13) disposed in circumferential substantially equal spaced apart relation of about 60 degrees. In embodiments including a circular sidewall (20) the open-sided channels (23) can comprise six open-sided channels disposed in circumferential substantially equal spaced apart relation of about 60 degrees.

In particular embodiments, the cup (22) can have a diameter D=about 1λ and height h=about 0.25λ. The cup (22) configured in this manner can increase the gain of the helix antenna (1) as compared to an infinite ground plane or a square ground plane, where λ is the wavelength at the central frequency of the antenna operating band. As an illustrative example, the cup (22) can have an inner diameter of about 21 inches (about 53 centimeters) and a sidewall height of about seven inches (about 18 cm). The cup (22) dimensions can be scaled to a comparable wavelength of operation.

The base plate (5) or the ground plane (5′) or the cup (22) can be configured to the comparable wavelength of operation. The wavelength of operation can comprise a frequency occurring in any portion of a range of about 30 MHz to about 3 GHz. As illustrative examples, the operational frequency of the helix antenna (1) can occur in a very high frequency (VHF) band in a range of about 240 MHz to about 270 MHz or in an ultrahigh frequency (UHF) band in a range of about 360 MHz to about 380 MHz. As to those embodiments having a plurality of helixes (10), each helix can singularly or concurrently be operated at a different operational frequency. The term plurality of helixes (10) means two or more helixes (10), and in particular embodiments: two helixes, three helixes, four helixes or a greater number of helixes (10).

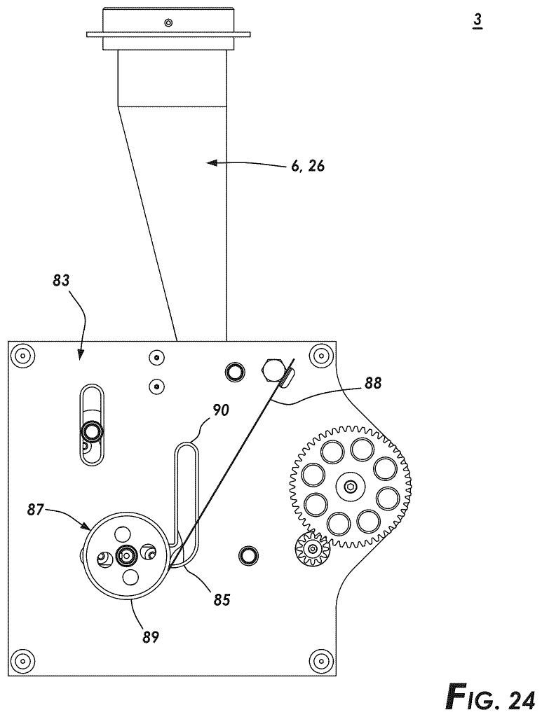

Now, with primary reference to FIGS. 10 through 17, in a particular embodiments, the stem (6) can comprise one or a combination of materials affording a structure reconfigurable between a flattened wound roll (25) or coil in the retracted condition and adapted or configured to assume a stable longitudinal slit tubular body (26) upon extension of the stem (6) from the flattened wound roll (25) or coil, with the stem edges (27, 28) generally disposed in opposed relation (whether adjacent or a distance apart) to define a slit along the longitudinal axis of a tubular body (26) (also referred to herein as a “longitudinally slit tube”). The stem (6) can have a stem first end (29) (as shown in the example of FIGS. 22 through 29) which can be disposed in the flattened wound roll (25) or coil below the base plate (5) or ground plane (5′) and which extends through a passthrough (30) in the base plate (5) or ground plane (5′) to assume the tubular body (26) above the base plate (5) or ground plane (5′) to terminate in a stem second end (31). In particular embodiments, the stem second end (31) can further include a stem cap (32) configured to engage the terminal bulkhead (8). The stem (6) can be produced, fabricated or formed from any material or layers of material from which the reconfigurable bistable structure can be obtained, including, as examples: a metal or a laminate of epoxy resin and fibers which can be conductive or dielectric fibers, or a combination of layers thereof.

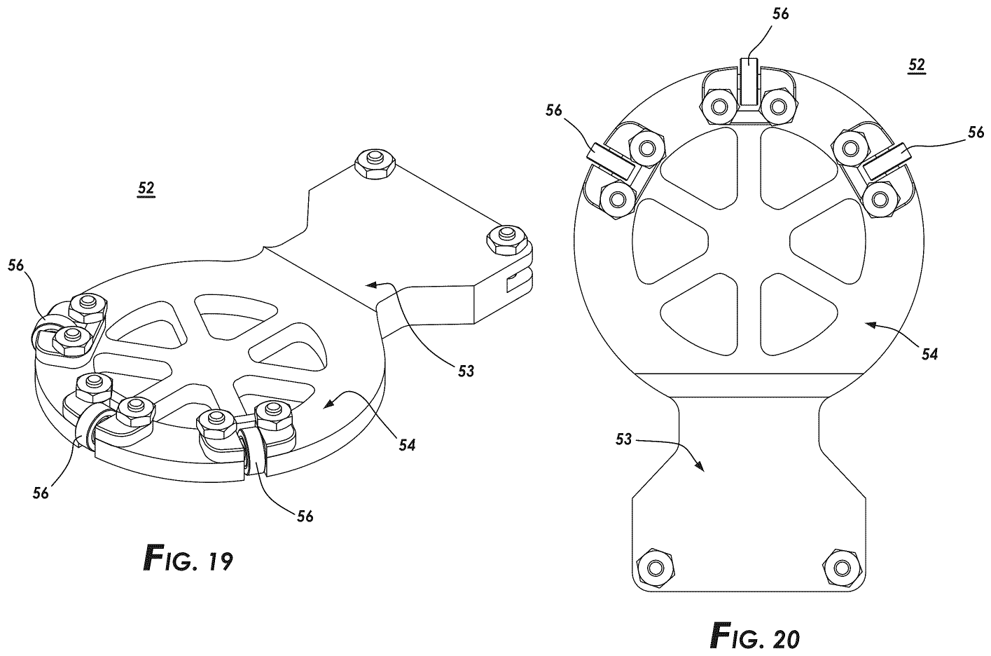

Now, with primary reference to FIGS. 1A through 20, embodiments of the invention can include a plurality of bulkheads (7) including a terminal bulkhead (8) coupled to the stem second end (31) and a plurality of intermediate bulkheads (9) slidably disposed on the stem (6) between the base plate (5) or ground plane (5′) and the terminal bulkhead (8). In particular embodiments, the terminal bulkhead (8) and each of the intermediate bulkheads (9) can each comprise a substantially flat triangular bulkhead (32) including three linear rods (33) each having a rod length (36) disposed between a pair of rod ends (34, 35) (as shown in the illustrative example of FIG. 18A). The rod ends (34, 35) can be interconnected to provide the three vertices (37, 38, 39) of the triangular bulkhead (32). The three rods (33) can each comprise a non-conductive material. In the particular embodiment depicted, the three rods (33) comprise carbon fiber rods of substantially equal length each having a diameter of about 0.125 inches (about 0.318 cm). The triangular bulkhead (32) can define an equilateral triangle with three vertices (37, 38, 39). A circle can be inscribed with three vertices (37, 38, 39) being tangent thereto having a diameter about equal to the circle defined by the plurality of upright supports (13) disposed in circumferential fixed spaced apart relation on the base plate (5) or around a ground plane circular perimeter (5″) or the inner diameter of the cup (22). In the illustrative example of FIGS. 1A and 1B, the diameter can be about 21 inches (about 53 centimeters). However, this illustrative embodiment, is not intended to preclude the use of bulkheads (7) defining other polygonal or circular configurations of the terminal or intermediate bulkheads (8, 9), nor is this illustrative embodiment intended to preclude terminal or intermediate bulkheads (8, 9) configured from flat sheet material rather than linear rods, nor preclude other dimensions that may be associated with a particular operational wavelength of the helix antenna (1).

Now, referring to FIGS. 18A and 18B, in particular embodiments, a vertex cap (40) can be coupled to each vertex (37, 38, 39) of the triangular bulkhead (32). In the illustrative embodiments, a vertex cap (40) can be coupled at each of the three vertices (37, 38, 39) of the triangular bulkhead (32). Each vertex cap (40) can have a configuration that receives and secures the rod ends (34, 35) to maintain the triangular bulkhead (32) in a substantially flat condition. In particular embodiments, each vertex cap (40) can include an outwardly extending channel follower (41) having a channel follower external surface (42) configured to slidably engage a corresponding open-sided channel (23) in one of the plurality of supports (13) or in the circular sidewall (20) of the cup (22). In the illustrative examples, the channel follower (41) includes a pair of channel follower sides (43, 44) joined by a channel follower end (45). The pair of channel follower sides (43, 44) of each channel follower (41) of the triangular bulkhead (32) can slidably engage a corresponding one of the plurality of open-sided channels (23) disposed in one of the plurality of upright supports (13), or in the an electrically conductive circular sidewall (20), to dispose each of the plurality of bulkheads (7) in face-to-face relation within the open space (19) of the cup (22) (as shown in the examples of FIGS. 1A, 1B and 2 through 5). In the particular embodiment of the helix antenna (1) depicted, the terminal bulkhead (8) and five intermediate bulkheads (9a, 9b, 9c, 9d, 9e) can be stacked face-to-face within the interior space (19) of the cup (22). However, depending on the embodiment a greater or fewer number of intermediate bulkheads (9) can be utilized. In the particular embodiment depicted, the plurality of open-sided channels (23) comprise six open-sided channels disposed in substantially equal circumferential spaced apart relation and the plurality of bulkheads (7) can be disposed in face to face stacked relation in the interior space (19) of defined by the open-sided channels (23) or the cup (22) with each triangular bulkhead (32) stacked in sequence with a rotational offset of 60 degrees to the adjacent one of the plurality of bulkheads (7).

Now, with primary reference to FIGS. 10 through 17, in particular embodiments, a cord network (46) can interconnect the plurality of bulkheads (7). The cord network (46) can be slack in the stowed condition (2) of the helix antenna (1). Upon deployment of the helix antenna (1) into deployed condition (4), the plurality of bulkheads (7) attain a bulkhead spacing (BHS) and the cord network (46) tensions to provides support to the helix antenna (1). As depicted in FIG. 10, the cords (47) that form the cord network (46) can be drawn diagonally to interconnect each adjacent pair of vertex caps (in the example of FIG. 10 (37′, 38′) of a first bulkhead (9a) with a corresponding offset vertex cap (37″) of a second bulkhead (9b) stacked adjacent the first bulkhead (9a) in the interior space of the cup (22). Cords (47a, 47b) diagonally drawn between adjacent bulkheads (9a, 9b) in the deployed condition (4) stiffen the helix antenna (1) against axial buckle and radial torsion along the antenna height (AH) of the helix antenna (1) in the deployed condition (4). Similarly, the pair of cords (47a, 47b) drawn diagonally to couple to one vertex cap (37″) of second bulkhead (9b) stacked adjacent and rotationally offset by 60 degrees to either of the adjacent pair of vertex caps (37′, 38′) of the first bulkhead (9a) can be correspondingly drawn diagonally from the one vertex cap (37″) of the second bulkhead (9b) to a pair of adjacent vertex caps (37′″, 39′″) of a third bulkhead (9c) stacked adjacent the second bulkhead (9b) in the interior space of the cup (22). The cord configuration can be repeated until the cord network (46) interconnects the plurality of bulkheads (7) of the helix antenna (1). Thereby, tensioning of the cord network (46) can be balanced and not create large bending moments in the helix antenna (1) during deployment and in the deployed condition (4) of the helix antenna (1). The cord network (46) when tensioned generates compressive forces which in interaction between the bulkheads (7) and the stem (6) resists buckling of stem (6).

Now, with primary reference to FIG. 18A, in particular embodiments, a hub (48) can be centrally supported inside each bulkhead (7). In the example of a triangular bulkhead (32). the hub (48) can be supported near the centroid of the triangular bulkhead (32) by median rods (49) each extending from a vertex cap (40) toward the midpoint of the opposite one of the three liner rods (33) of the triangular bulkhead (32) to connect to the hub (48). Each hub (48) can have a hub outer periphery (49) which can connect to the median rods (49) and a hub inner periphery (50) defining a stem passthrough (51). The stem passthroughs (51) of the plurality of bulkheads (7) align when disposed in the stowed condition (2) in the cup (22). The stem (6) passes through each stem passthrough (51) of the plurality of intermediate bulkheads (7, 9) to couple the stem second end (31) to the terminal bulkhead (7, 8).

Again, with primary reference to FIGS. 18A and 19 through 20, each hub (48) can include a stem guide (52) disposed in the stem passthrough (51). In particular embodiments, the stem guide (52) can have a stem guide neck (53) coupled to the hub inner periphery (50) and a stem guide head (54) configured to slidably engage the tubular body internal surface (55) of the stem (6) with stem guide neck (53) extending through the longitudinal slit (78) in the tubular body (6, 26). In particular embodiments, the stem guide (52) can, but need not necessarily, include one or more first roller elements (56) rotationally coupled to the stem guide head (54) opposite the stem guide neck (53). The one or more first roller elements (56) can rotationally engage the tubular body internal surface (55). In particular embodiments, one or more second roller elements (57) can be rotational coupled to the hub inner periphery (50) and disposed in opposed relation to the one or more first roller elements (56) to rotationally engage the tubular body external surface (58). The one or more first roller elements (56) and/or the one or more second roller elements (57) can be springingly biased to allow the one or more first roller elements (56) or the one or more second roller elements (57) to correspondingly track the movement, features, or irregularities of the tubular body internal surface (55) or the tubular body external surface (58).

Again, with primary reference to FIGS. 1A and 1B, an annular member (59) can be circumferentially disposed about the hub (48) of the terminal bulkhead (7, 8). In particular embodiments, the annular member (59) can be supported by one or more spokes (60) radially extending between the hub outer periphery (49) to an annular member inner periphery (62). The annular member outer periphery (62) can be circular with an annular member diameter (AMD) comparable to the wavelength of operation of the helix antenna (1). A plurality of straps (63) having strap first ends (64) can be connected in circumferentially fixed spaced apart relation to the annular member outer periphery (62) and strap second ends (65) can be connected in corresponding fixed spaced apart relation to the base plate (5) or ground plane (5′). In particular embodiments, the strap first ends (64) and/or the strap second ends (65) can be correspondingly flexibly or springingly connected to allow the straps to balance tension in the plurality of straps (63) to not create large bending moments in the helix antenna (1). The strap medial portions (66) can be affixed to the intermediate bulkheads (7, 9). Strap medial portions (66) between intermediate bulkheads (7, 9) can be slack in the stowed condition (2) of the helix antenna (1). Upon deployment of the helix antenna (1) into the deployed condition, the straps (63) can tension to provide support to the helix (10) in the deployed condition (4).

Now, with primary reference to FIGS. 10 through 17, one or more helix(es) (10) of electrically conductive material can be disposed around the stem (6) between a helix first end (11) coupled to the base plate (5) or ground plane first side (67) with a feeder line (68) and a helix second end (12) coupled to the annular member (59) of the terminal bulkhead (8). In particular embodiments, the helix (10) of electrically conductive material can be coupled to the one more of the plurality of straps (63). The helix(es) (10) of electrically conductive material can comprise a wire or tape of electrically conductive material. As an illustrative example, the electrically conductive material can comprise beryllium copper (BeCU), a copper alloy with about 0.5% to about 3% beryllium. In particular embodiments the helix (10) can comprise a wound strap (10′) of BeCU; however, this example is not intended to preclude embodiments that comprise other kinds of electrically conductive material depending on the application. In particular embodiments, the wound strap (10′) having a strap width (SW) of about 0.313 inches (about 8.0 mm) and a strap thickness (ST) of about 0.040 inch (about 1 mm). The helix antenna (1) can be disposed in the deployed condition (4) where the stem (6) extends in spatial relation to the ground plane (5) to dispose the terminal bulkhead (7, 8) at an overall antenna height (AH) in relation to the ground plane (5) with the intermediate bulkheads (7, 9) disposed in spaced apart relation (BHS) between the terminal bulkhead (7, 8) and the ground plane (5). The deployed condition (4) tensions the cord network (6) and the straps (63) to dispose the helix (10) of electrically conductive material at an overall helix height (HH) and a helix diameter (HD) and a helix pitch (HP) comparable to the wavelength (λ) of operation. The wavelength of operation can comprise a frequency occurring in any portion of a range of about 30 MHz to about 3 GHz. The wavelength of operation can occur concurrently or separately in a plurality of frequency bands (69, 70). As an illustrative example, a first very high frequency band occurring in the range of about 240 MHz to about 270 MHz (69) and a second ultra-high frequency band occurring in the range of about 360 MHz to about 380 MHz (70). The helix can be configured to operate in these frequency bands with a circular ground plane (5′) having a ground plane diameter (GPD) of about 21.654 inches (about 550 mm) with deployed dimensions including a bulkhead spacing (BS) of about 41.18 inches (about 1.045 meter), a helix height (HH) of about 205.9 inches (5.230 meters) and a helix diameter (HD) of about 11.024 inches (about 280 mm).

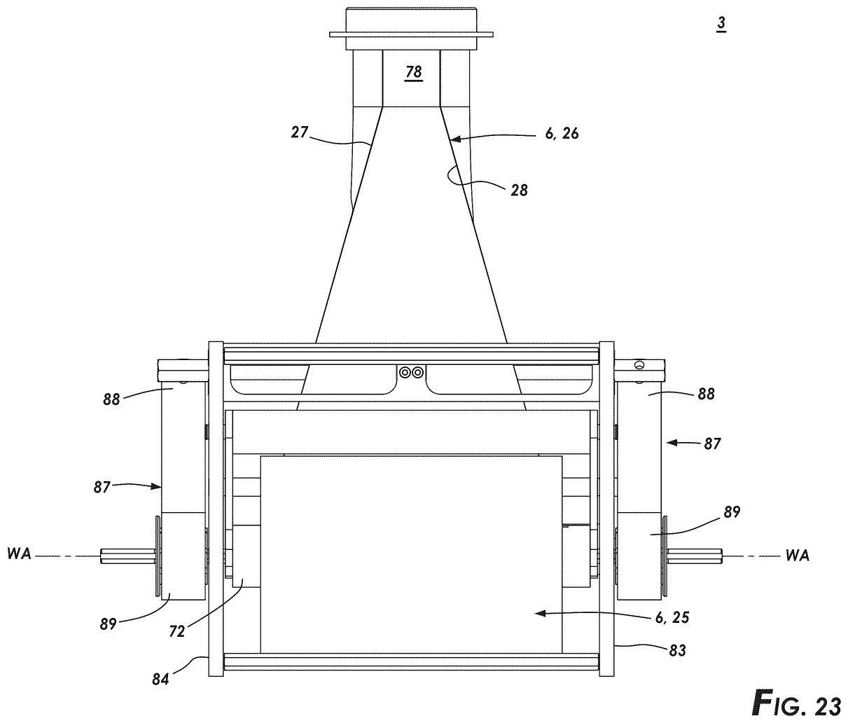

Now, with primary reference to FIGS. 21 through 29, embodiments of the helix antenna (2) can further include an antenna deployer (3) coupled to the base plate or a ground plane second side (71) with the stem (6) extending through the passthrough (30). Embodiments of the antenna deployer (3) operate to extend or retract the stem (6) to correspondingly move the helix antenna (1) from the stowed condition (2) within the cup (22) to the deployed condition (4) upwardly extending from the cup (22). In particular embodiments, the antenna deployer (3) can include a first spool (72). The stem first end (29) can be coupled to the first spool (72). The first spool (72) can be rotated in a first direction to wind the stem (6) around the first spool (72) in a substantially flattened wound roll (25) in the stowed condition (2) of the helix antenna (1). The first spool (72) can be rotated in a second direction to deploy the stem (6) from the substantially flattened wound roll (25) on the first spool (72) to afford an extended longitudinal slit tubular body (26) in the deployed condition (4) of the helix antenna (1). In particular embodiments, the first spool (72) may be rotated through geared transmission to a motor (73) to afford the flattened wound roll (25) of the stem (6) and the extended longitudinal slit tubular body (26).

In the particular embodiment of the antenna deployer (3) depicted in the Figures, the stem (6) can be disposed in the flattened wound roll (25) on the first spool (72) with the stem first end (29) extending through the ground plane passthrough (30). A clutch mechanism (74) can be disposed about the winding axis (WA) of the first spool (72) adjacent one or both first spool ends (75). The clutch mechanism (74) operates to engage one or both of the first spool ends (75) to resist rotation of the first spool (72) to prevent self-deployment of the stem (6) due to structural bias in the stem (6) toward forming the longitudinally slit tube (26). A flexible deployer tape (76) can have a deployer tape first end (77) connected to the stem external surface (58) proximate the stem second end (31) and opposite the longitudinal slit (78). The flexible deployer tape (76) can be wound with stem (6) about the first spool (72) to provide a concurrent winding of the stem (6) and flexible deployer tape (76) in the flattened wound roll (25) of the stem (6). The deployer tape (72) includes a deployer tape second end (79) coupled to a second spool (80). The deployer tape medial portion (81) can be conveyed over or through a deployer tape guide (82) configured to maintain a portion of the deployer tape medial portion (81) substantially axially aligned and adjacent the stem (6). The second spool (80) can be rotated to wind the deployer tape (76) around the second spool (80). As the flexible deployer tape (80) winds about the second spool (80) the deployer tape medial portion (81) unwinds from the first spool (72) and corresponding rotates the first spool (72) to corresponding unwind the stem (6) from the first spool (72) to assume the longitudinally slit tubular body (26). The second spool (80) can be rotated through geared transmission of a motor (73). The first spool (72) and the second spool (80) can be rotatably journaled between a pair of deployer end pieces (83, 84). In particular embodiments, the first spool (72) can have first spool ends (75) correspondingly rotatingly journaled in a pair of antenna deployer end piece slots (85, 86) configured to allow the first spool winding axis (WA) to move and remain aligned with the central longitudinal antenna axis (AA) of the longitudinal slit tube (26) as wound diameter of the stem (6) on the first spool (72) changes during stowage or deployment of the stem (6). In particular embodiments, one or a pair of negator springs (87) can be rotatably mounted about the winding axis (WA) of each first spool end (75) with the negator spring free end (88) coupled at a fixed position on one of the pair of deployer end pieces (83, 84). The negator springs (87) can comprise ribbon springs that form a ribbon spring coil (89) in a relaxed condition. The negator springs (88) can be tensioned by being unwound from the ribbon spring coil (89) when the first spool winding axis (WA) has a location in the deployer end piece slots (85, 86) distal from the negator spring free ends (88). The negator springs (87) can apply essentially constant torque on the first spool ends (75) to move the first spool (72) in the corresponding pair of deployer end piece slots (85, 86) to correspondingly maintain the first spool winding axis (WA) aligned with the slit tube longitudinal axis (AA) as the stem (6) unwinds from the first spool (72). In particular embodiments, the pair of deployer end piece slots (85, 86) can be further configured to include axial slots (90, 91) on the pair of deployer end pieces (83, 84) substantially aligned with the central longitudinal axis (AA) of the slit tube (26). The axial slots (90, 91) provide a range of motion for the stem (6) in the axial direction. The negator springs (87) provide a force and spring rate over the range of motion for the stem (6) in axial direction. This allows the STEM to maintain an axial force over a range of tolerance, structural or thermal distortion, or imbalance during operation. The stem (6) therefore only needs to provide sufficient structural integrity to carry its own internal forces. The stem (6) doesn't need to fully unwind to provide the axial forces to maintain the deployed condition (4).

As can be easily understood from the foregoing, the basic concepts of the present invention may be embodied in a variety of ways. The invention involves numerous and varied embodiments of an antenna and methods for making and using such antenna including the best mode.

As such, the particular embodiments or elements of the invention disclosed by the description or shown in the figures or tables accompanying this application are not intended to be limiting, but rather illustrative of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “deployer” should be understood to encompass disclosure of the act of “deploying”—whether explicitly discussed or not—and, conversely, were there effectively disclosure of the act of “deploying”, such a disclosure should be understood to encompass disclosure of a “deployer” and even a “means for deploying.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in Merriam-Webster's Collegiate Dictionary, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the antenna herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An antenna, comprising:
a stem having a longitudinally slit tubular body disposed between a stem first end and a stem second end;
a plurality of bulkheads including a terminal bulkhead coupled to said stem second end and a plurality of intermediate bulkheads slidably disposed on said stem between said stem first end and said stem second end; and
a helix of electrically conductive material disposed around said stem between a helix first end coupled to a base plate and a helix second end coupled to said terminal bulkhead.

2. The antenna of claim 1, further comprising a passthrough in said base plate, said stem extending through passthrough.

3. The antenna of claim 2, wherein said base plate configured as a ground plane.

4. The antenna of claim 3, wherein said ground plane has a circular perimeter.

5. The antenna of claim 4, further comprising a sidewall circumferentially coupled to and upwardly extending about said circular perimeter of said ground plane.

6. The antenna of claim 1, wherein said terminal bulkhead and each of said plurality of intermediate bulkheads comprise a plurality of triangular bulkheads.

7. The antenna of claim 6, wherein each successive one of said plurality of triangular bulkheads having a rotational offset.

8. The antenna of claim 7, wherein each successive one of said plurality of triangular bulkheads having said rotational offset of about 60 degrees.

9. The antenna of claim 7, further comprising a vertex cap coupled at each triangular bulkhead vertex.

10. The antenna of claim 9, further comprising a cord network interconnecting said plurality of bulkheads, said cord network comprises pairs of cords drawn diagonally to interconnect each adjacent pair of vertex caps of a first bulkhead with each successive rotationally offset vertex cap of a second bulkhead.

11. The antenna of any one of claim 1, further comprising a plurality of upright supports disposed in circular fixed spaced apart relation on said base plate.

12. The antenna of claim 11, further comprising a plurality of open sided channels disposed in circumferential fixed spaced apart relation in said sidewall or one of said plurality of open sided channels disposed in each of said plurality of upright supports.

13. The antenna of claim 12, wherein said terminal bulkhead and each of said plurality of intermediate bulkheads comprise a plurality of triangular bulkheads.

14. The antenna of claim 13, further comprising a vertex cap coupled at each triangular bulkhead vertex of each of said plurality of triangular bulkheads, said vertex cap including an outwardly extending channel follower having a channel follower external surface configured to slidably engage one of said plurality of open sided channels.

15. The antenna of claim 14, wherein each said channel follower of each said vertex cap correspondingly slidingly engages one of said plurality of open sided channels to stack said plurality of triangular bulkheads.

16. The antenna of claim 15, wherein each said channel follower slidingly engaged in a corresponding one of said plurality of open sided channels rotationally offsets each successive one of said plurality of triangular bulkheads.

17. The antenna of claim 16, wherein said plurality of open sided channels comprise six open sided channels and each successive one of said plurality of triangular bulkheads having said rotational offset of about 60 degrees.

18. The antenna of claim 17, further comprising a cord network interconnecting said plurality of bulkheads, said cord network comprises pairs of cords drawn diagonally to interconnect each adjacent pair of vertex caps of a first bulkhead with each successive rotationally offset vertex cap of a second bulkhead.

19. The antenna of claim 13, further comprising a hub centrally supported inside each of said plurality of triangular bulkheads, said hub having an inner periphery defining a stem passthrough configured to slidingly engage said stem.

20. The antenna of claim 19, further comprising stem guide having a stem guide neck coupled to a hub inner periphery and a stem guide head configured to slidably engage said longitudinally slit tubular body internal surface of said stem with said stem guide neck extending through a longitudinal slit in said longitudinally slit tubular body.

21. The antenna of claim 20, further comprising one or more first roller elements rotationally coupled to the stem guide head opposite said stem guide neck, said one or more first roller elements rotationally engage said tubular body internal surface.

22. The antenna of claim 21, further comprising one or more second roller elements rotational coupled to the hub inner periphery and disposed in opposed relation to said one or more first roller elements to rotationally engage said tubular body external surface.

23. The antenna of claim 22, wherein said one or more first roller elements and/or said one or more second roller elements springingly biased to allow movement of said one or more first roller elements and/or said one or more second roller elements in spatial relation to said stem guide head and/or said hub inner periphery.

24. The antenna of claim 1, further comprising:
an annular member circumferentially disposed about said hub of said terminal bulkhead; and
a plurality of straps having strap first ends connected in circumferentially fixed spaced apart relation to said annular member, and strap second ends connected in corresponding fixed spaced apart relation to said base plate.

25. The antenna of claim 24, wherein a medial portion of said helix supportingly coupled to said plurality of straps.

26. The antenna of claim 14, wherein said antenna having a stowed condition, wherein said stem disposed in retracted spatial relation to said base plate, wherein each said channel follower correspondingly extending from each said triangular bulkhead vertex correspondingly slidably engages one of said plurality of open sided channels to stack said plurality of bulkheads in a face-to-face relation.

27. The antenna of claim 26, wherein said antenna having a deployed condition, wherein said stem in an extended spatial relation to said ground plane, said terminal bulkhead disposed at an overall height in relation to said base plate, said plurality of bulkheads disposed in spaced apart relation between said terminal bulkhead and said ground plane to dispose said helix of electrically conductive material at a diameter and pitch corresponding to a wavelength of operation.

28. The antenna of claim 27, wherein said wavelength of operation comprises a frequency occurring in the range of about 30 MHz to about 3 GHz.

29. The antenna of claim 27, wherein said wavelength of operation comprises a frequency occurring in the range of about 240 MHz to about 270 MHz in a very high frequency band.

30. The antenna of claim 27, wherein said wavelength of operation comprises a frequency occurring in the range of about 360 MHz to about 380 MHz in an ultra-high frequency band.

31. The antenna of claim 27, further comprising a stem deployer coupled to said base plate second side, said stem deployer configured to retractably extend said stem in spatial relation to said base plate to afford said stowed condition and said deployed condition of said antenna.

32. The antenna of claim 1, wherein said helix of electrically conductive material disposed around said stem comprises a plurality of helixes.

33. The antenna of claim 32, wherein each of said plurality of helixes operates singularly or concurrently at a different operational frequency.

34. The antenna of claim 33, wherein said plurality of helixes comprises two helixes, three helixes, or four helixes.

35-102. (canceled)
